(19) United States
(12) Patent Application Publication
(10) Pub. No.: US 2008/0103225 A1
(43) Pub. Date: May 1, 2008

(54) MANUFACTURING METHOD OF RESIN COMPOSITE PARTICLE, RESIN COMPOSITE PARTICLE, MANUFACTURING METHOD OF FIBER TREATING AGENT AND FIBER TREATING AGENT

(76) Inventors: Masashi SAKAMOTO, Sodegaura-shi (JP); Takeharu TAJIMA, Sodegaura-shi (JP); Ichiro MIURA, Fukui-shi (JP); Takuji NAKAYAMA, Fukui-shi (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/875,392

(22) Filed: Oct. 19, 2007

Related U.S. Application Data
(60) Provisional application No. 60/852,998, filed on Oct. 20, 2006.

(51) Int. Cl. C08K 5/13; C08J 3/28

(52) U.S. Cl. 522/79; 523/202; 522/153; 522/109

(57) ABSTRACT

A surfactant and water are added to a solution containing at least a functional component and a monomer to make emulsion and the total concentration of the functional component and the monomer in the emulsion containing the functional component, the monomer, the surfactant, and the water is then adjusted to 10 to 50%, followed by polymerizing the mixture of the solution, the surfactant, and the water by application of heat or ultraviolet radiation, whereby a resin composite particle can be obtained. Subsequently, the resin composite particle is mixed with an adhesive resin to obtain a fiber treating agent.

### TECHNICAL FIELD

The present invention relates to a method of manufacturing a resin composite particle, a resin composite particle, and a method of manufacturing a fiber treating agent and a fiber treating agent.

### BACKGROUND ART

Conventionally, various products using fiber, such as blouse, dress shirts, pants, skirts, backing clothes, covering materials for furniture and seats of vehicles, have been supplied in the market.

In those fiber products, fiber provided as their materials requires different functional properties depending on various kinds of applications. The required functional properties include, for instance, moisture-retaining property, water-absorbing property, moisture-absorbing property, aromatic property, and antistatic property.

For providing fiber products with those functional properties, attempts to treat the fiber products with fiber treating agents containing specific functional components have been conducted.

For durable adhesion of the functional component on the fiber product, there is known a method in which the functional component, if it is a substance insoluble to water or an organic solvent, is pulverized and then used for processing together with an adhesive resin.

On the other hand, if the functional component is a substance soluble to water or an organic solvent, the functional component may be encapsulated in a microcapsule to retain its functional properties by preventing the functional component from running into water at the time of washing or the like. For preventing the loss of active components by water release at the time of washing or the like, Patent Document 1 describes a method in which active components are encapsulated in microcapsules and used for processing of fiber together with a binder.

[Patent Document 1] Published Japanese translation of PCT application No. 2005-529246

### DISCLOSURE OF THE INVENTION

### Problems to be Solved by the Invention

In general, when the particle size of a microcapsule exceeds 1 μm, the percentage of microcapsules infiltrating in the fiber is low, so that they may be fallen off by washing. When the percentage of an adhesive resin is increased for avoiding such a trouble, the adhesive resin may accumulate on the surface of fiber and damage the texture of textile.

However, the microcapsules described in Patent Document 1 have an average diameter of 0.0001 to 5 mm and thus the percentage thereof to infiltrate in the fiber structure is low. Besides, the manufacturing method described in Patent Document 1 has a complicated process of microcapsule encapsulation and requires a multilayer structure. In addition, capsules require to have a multilayer structure, so that it is extremely difficult to produce capsules with an average particle size of 1 μm or less especially when a liquid or an amorphous solid, such as a natural organic substance, is employed.

An object of the present invention to provide a method of manufacturing a resin composite particle, a resin composite particle, and a method of manufacturing a fiber treating agent and a fiber treating agent, whereby the size of the resin composite particle can be decreased, infiltration of the resin composite particle into fiber can be improved, and sustained release of a functional component in the resin composite particle can be improved.

### Means for Solving the Problems

A method of manufacturing a resin composite particle according to an aspect of the present invention relates to a method of manufacturing a resin composite particle contained in a fiber treating agent to be used in treatment of a surface of fiber, including: adding a surfactant and water to a solution containing at least a functional component and a monomer to make an emulsion; adjusting a total concentration of the functional component and the monomer in the emulsion containing the functional component, the monomer, the surfactant, and the water to 10 to 50%; and polymerizing the mixture of the solution, the surfactant, and the water by application of heat or ultraviolet radiation to obtain a resin composite particle.

In the present invention, a monomer is polymerized and resinified in a state where the functional component is dissolved in the monomer. In other words, since the functional component dissolves in a resin to form a composite, no multilayer structure is required. Thus, nano-sized resin composite particles can be produced because of no need of the complicated encapsulation process as in the method of manufacturing a microcapsule described in Patent Document 1. In addition, because of no multilayer structure, an improvement in sustained-release is attained without sudden flow of contents by break of a capsule.

Further, in an emulsion containing a functional component, a monomer, a surfactant, and water, the total concentration of the functional component and the monomer can be adjusted to 10 to 50% to enable the production of nano-sized resin composite particles.

### BEST MODE FOR CARRYING OUT THE INVENTION

Hereinafter, components that constitute a resin composite particle will be described.

In the method of manufacturing the resin composite particle of the present invention, a functional component is preferably one having a LogPow value (n-octanol/water partition coefficient) of 0 or more. In other words, the functional component of the present invention has properties of easily dissolving in an organic solvent but hardly dissolving in water.

It is desirable that the functional component of the present invention be a composite containing an oligopeptide in which N-terminal is bounded by aliphatic fatty acid to form an amide bond, a plant-origin aromatic component, or a hydrophobized degenerated substance of a polyphenol.

Specifically, examples of the functional component include: plant extracts such as terpene, polyphenol, carotene, tocopherol, and crop oil; oligopeptides of animal/plant-derived proteins, (deoxy)ribo nucleic acids, and partially-degenerated products thereof; natural or synthetic aromatic compounds; and antioxidative fatty acids (e.g., DHA).

A fiber product can be provided with functional properties of the respective functional components by treating the fiber product using resin composite particles with the functional components as a fiber treating agent as described later.

For example, polyphenol has properties of antibacterial/antivirus, antioxidation, deodorization, and the like, and those functional properties can be imparted to the fiber product.

Monomers are each composed of at least one of acrylic acid-based, methacrylic acid-based, maleic acid-based, vinyl ester-based, vinyl ether-based, and styrene-based monomers.

Examples of the acrylic acid-based monomer include acrylic acid, sodium acrylate, an acrylic ester having 1 to 12 carbon atoms in which C₁ to C₁₂ branched chain alkyl is optionally included, and (di)alkyl amide having 1 to 6 carbon atoms.

Examples of the methacrylic acid-based monomer include methacrylic acid, sodium methacrylate, a methacrylic ester having 1 to 12 carbon atoms in which C₁ to C₁₂ branched chain alkyl is optimally included, and (di)alkyl amide having 1 to 6 carbon atoms.

Examples of the maleic acid-based monomer include maleic acid, maleic anhydride, and (di)alkyl ester having 1 to 6 carbon atoms.

An example of the vinyl ester-based monomer includes acid having 2 to 8 carbon atoms. In addition, an example of the vinyl ether-based monomer includes alkyl ether having 2 to 8 carbon atoms.

In addition, the addition of a crosslinkable monomer allows the resin composite particle to be incorporated into a crosslinked structure of the crosslinkable monomer, increases the hardness of the resin composite particle, and improves the retentivity of the functional component.

Examples of the crosslinkable monomer include ethylene glycol diacrylate, ethylene glycol dimethacrylate, tetramethylene glycol diacrylate, polyoxyethylene glycol di(meth)acrylate, and polyoxypropylene glycol di(meth)acrylate.

When the crosslinkable monomer is added, the amount to be added is preferably in the range of 0 to 5% by mass with respect to 100% by mass in total of monomers including the crosslinkable monomer. If it exceeds 5% by mass, even if it is increased further, there is no effect of making a polymer structure polymerized by the crosslinked structure hard to be collapsed. A more preferable amount to be added is in the range of 0.2 to 3% by mass.

Examples of the surfactants which can be used herein include any of anionic, nonionic, and cationic surfactants.

Examples of the anionic surfactant include dioctyl sodium sulfosuccinate, sodium p-dodecylbenzene sulfonate, and sodium-tridecyl-polyoxyethylene sulfonate.

Examples of the nonionic surfactant include polyoxyethylene-monododecyl ether, polyoxyethylene/propylene-monotridecyl ether, and decaglycerine-mono/dodecyl ether.

Examples of the cationic surfactant include dodecyltrimethyl ammonium chloride, di(dodecyltrimethyl ammonium)-sulfonate, and ethyldimethyltridecyl ammonium-ethanesulfonate.

In the mixture of the surfactant and the monomer, the blending ratio of the surfactant to the monomer is preferably not more than 1:3 (surfactant:monomer).

Even if the blending ratio of the surfactant exceeds it, the dispersibility in the mixture of the functional component and the monomer cannot be improved and a decrease in adhesion performance of a binder resin may thus occur in fiber processing.

A method of manufacturing a resin composite particle by mixing the constituents described above will be described.

First, a functional component is dissolved in a monomer.

The weight ratio of the functional component to the monomer is preferably 1:3 to 1:10 (functional component:monomer). It is more preferably 1:4 to 1:6 (functional component:monomer).

If the monomer ratio is smaller than 1:3 (functional component:monomer), the softening point of a resin composite particle decreases to cause deformation of the resin composite particle and facilitate the efflux of the functional component. In contrast, if the monomer ratio is higher than 1:10 (functional component:monomer), the functional component shows poor efficiency and the functional properties thereof cannot be practically obtained.

If the functional component is not dissolved in a mixture composed of only monomers, it is preferable to add any of higher alcohols, mineral oils, and vegetable oils to the mixture.

The higher alcohols include alcohols each having 6 to 18 carbon atoms and also include their branched ones. Therefore, the functional component can be uniformly dissolved in the monomer in an efficient manner. Further, when the functional component is a volatile component such as an aromatic substance, there is also an inhibitory effect on volatilization.

Next, the monomer solution in which the functional component is dissolved is emulsified by the addition of a surfactant and water.

An emulsion is prepared by adding a surfactant to the solution composed of the functional component and the monomer, and then mixing the mixture with water. In this case, the total concentration of the functional component and the monomer is preferably in the range of 10 to 50%.

If the concentration is less than 10%, in addition to a decrease in production efficiency of a resin composite particle to be obtained, the functional component dissolved in water may increase and the concentration of active components in the resultant resin composite particle tends to decrease.

If the concentration exceeds 50%, the particle sizes of particles obtained by a polymerization reaction tend to be large, so that the object of the present invention, which is to obtain particles of 500 mm or less in size, cannot be achieved.

The reaction temperature for polymerization by heat is preferably in the range of 50 to 120° C., more preferably in the range of 80 to 100° C. If the reaction temperature is less than 50° C., the polymerization of monomers may hardly proceed. If the reaction temperature exceeds 120° C., water may come to boil.

In addition, for polymerization by heat, a polymerization initiator may be used together as needed. The polymerization initiator which can be used may be any of water-soluble polymerization initiators and fat-soluble polymerization initiators.

Examples of the water-soluble polymerization initiator include 2,2′-azobis(isobutylamine)dihydrochloride salt and ammonium persulfate.

Examples of the fat-soluble polymerization initiator include lauroyl peroxide, m-chloroperbenzoic acid, α,α′-azobis isobutyronitrile.

The resin composite particles thus obtained preferably have an average particle size of 500 nm or less.

According to the present invention, the resin composite particles have an extremely small average particle size of 500 nm or less, so that the resin composite particles can be deeply impregnated into the fiber structure by incorporating the resin composite particles in a fiber treating agent described later and then treating the fiber product with the fiber treating agent. Therefore, the resin composite particles each containing the functional component can be more hardly dropped off by washing, ablation, or the like, so the functional properties of the functional component can be retained for a long period of time.

Next, the fiber treating agent containing the resin composite particle described above will be described.

In the method of manufacturing a fiber treating agent of the present invention, the fiber treating agent is preferably obtained by mixing the resin composite particle with an adhesive resin.

According to the present invention, the fiber treating agent contains the resin composite particle having the advantages and effects as described above. A fiber product treated with the fiber treating agent retains nano-sized resin composite particles deeply impregnated into the fiber structure. Therefore, the nano-sized resin composite particles are hardly dropped off by washing or the like, so washing durability and wear durability can be markedly superior.

In addition, an appropriate adhesive resin is used together to allow the composition resin particles to be surely adhered and also realize an igloo type adhesion form, so the sustained-release of the functional component from the resin composite particles can be further controlled. As a result, the function of the functional component included in the composition resin particles can be retained for a long period of time.

A preferable adhesion resin is one having thermosetting property, such as at least one of acrylic-based, silicon-based, and polyurethane-based resins.

Specific examples of the adhesive resin include: homopolymers each of which is derived from (meth)acrylic acid ester, (meth)acrylic acid, or (meth)acrylic acid sodium salt, or copolymers thereof; siloxane; homopolymers each of which is derived from (meth)acrylate containing an ester residue with modified silicone or copolymers thereof with a (meth)acrylate-based monomer.

In addition, those resins each having a thermocrosslinkable functional group are preferable. Examples of the resins include resins each having an epoxy group or an aziridyl group in a part of (meth)acrylic acid ester residues thereof, resins each having a methoxycarbamate group, an ethoxycarbamate group, or a phenoxycarbamate group in a part of urethane terminals thereof.

Examples of the resins further include crosslinking polymers derived from polyoxyethylene glycol and/or polyesterdiol and hexamethylenediisocyanate, toluenediisocyanate, or the like.

According to the present invention, the adhesive resin allows the resin composite particles to strongly adhere to the fiber structure.

In addition, the resin composite particles are small as 500 nm in average particle size. Thus, the permeability of the resin composite particles to the fiber structure is high, so that the amount of the adhesive resin can be reduced. Therefore, a white appearance and texture degradation by the adhesive resin can be eliminated and material costs can be also reduced.

The solid weight ratio of the resin composite particles to the adhesive resin is preferably 2:3 to 10:1 (resin composite particles:adhesive resin), more preferably 3:2 to 5:1 (resin composite particles:adhesive resin). If the ratio of the resin composite particles to the adhesive resin is smaller than 2:3 (resin composite particles:adhesive resin), the adhesive resin is excessive and the texture of a fiber product degrades while the sustained-release of resin components is inhibited by the excess adhesive resin, thereby deteriorating functional properties. In addition, if the ratio of the resin composite particles to the adhesive resin is larger than 10:1 (resin composite particles:adhesive resin), the resin composite particles may be dropped off due to a lack of the adhesive resin.

The fiber treating agent thus obtained is used for treating a fiber product.

Examples of the fiber as a raw material include synthetic fiber (e.g., polyester, nylon, and acryl), semisynthetic fiber (e.g., acetate), regenerated fiber (e.g., rayon and cupra), natural protein fiber (e.g., wool and silk), and natural cellulose fiber (e.g., cotton, hemp, kenaf, banana, and bamboo).

It is more preferable that natural cellulose fiber be used. The fiber is formed with an abundance of irregularities, so the nano-sized resin composite particles can easily infiltrate in deep portions.

The configuration of fiber to be treated with the fiber treating agent may be any of thread, fabric, nonwoven fabric, knitting, and the like.

Specific methods of treating the fiber product with the fiber treating agent include dipping, pad-dry of textile, uptake processing, cheese staining of thread (bobbin), and spray dray.

The resin composite particles of the present invention is preferably one prepared by the method of manufacturing the resin composite particles as described above.

According to the present invention, since the resin composite particles are produced by the above manufacturing method, the resin composite particles can exert the same advantages and effects as those described above.

The fiber treating agent of the present invention is preferably one prepared by the manufacturing method described above.

According to the present invention, since the fiber treating agent is produced by the above manufacturing method, fiber treating agent can exert the same advantages and effects as those described above.

### EXAMPLES

Next, the present invention will be described more specifically with reference to examples and comparisons. First, the particle sizes of resin composite particles prepared in the following Example 1, Example 2, and Comparison 1 were measured, respectively.

### Example 1

As a functional component, a mixture of 1 part by volume of aromatic oil, VIE D'AROME “Rosemarry Camphor” Essential Oil (manufactured by Rohto Pharmaceutical Co., Ltd.) in 5 parts by volume of commercially available olive oil was used.

As monomer components, methyl acrylate and butyl methacrylate were used. In addition, dodecyl alcohol was used as a higher alcohol component and diisobutyl peroxide was used as a polymerization initiator.

A functional component solution was prepared by mixing 100 parts by mass of the functional component, 250 parts by mass of methyl acrylate, 250 parts by mass of butyl methacrylate, 25 parts by mass of the polymerization initiator, and 50 parts by mass of higher alcohol.

The solution thus prepared was added with 100 parts by mass of Neocoal SW-C (manufactured by Dai-ichi Kogyo Seiyaku Co., Ltd.) as a surfactant, and then added with 1225 parts by mass of water, thereby forming emulsion.

The resultant emulsion solution was heated to 80° C. and then the monomers were polymerized, thereby obtaining resin composite particles.

### Example 2

A functional component solution was prepared by mixing 100 parts by mass of the functional component, 100 parts by mass of methyl acrylate, 100 parts by mass of butyl methacrylate, 10 parts by mass of the polymerization initiator, and 50 parts by mass of the higher alcohol, which were the same as those used in Example 1.

The solution thus prepared was added with 60 parts by mass of Neocoal SW-C (manufactured by Dai-ichi Kogyo Seiyaku Co., Ltd.) as a surfactant, and then added with 655 parts by mass of water, thereby forming emulsion.

The resultant emulsion solution was heated to 80° C. and then the monomers were polymerized, thereby obtaining resin composite particles.

### Example 3

As a functional component, N-amidated oligopeptide, Max-Lip (manufactured by Zedama, Co., Ltd.), was used.

As monomer components, ethyl acrylate, methyl methacrylate and ethyl methacrylate were used. In addition, nonyl alcohol was used as a higher alcohol component and diisobutyl peroxide was used as a polymerization initiator.

A functional component solution was prepared by mixing 100 parts by mass of the functional component, 100 parts by mass of ethyl acrylate, 200 parts by mass of methyl methacrylate, 200 parts by mass of ethyl methacrylate, 30 parts by mass of the polymerization initiator, and 50 parts by mass of higher alcohol.

The solution thus prepared was added with 100 parts by mass of TS-1500 (manufactured by TOHO Chemical Industry Co., Ltd.) as a surfactant, and then added with 1220 parts by mass of water, thereby forming emulsion.

The resultant emulsion solution was heated to 80° C. and then the monomers were polymerized, thereby obtaining resin composite particles.

[Comparison 1]

A functional component solution was prepared by mixing 100 parts by mass of the functional component, 250 pars by mass of methyl acryalte, 250 parts by mass of butyl methacryalte, 25 parts by mass of the polymerization initiator, and 50 parts by mass of the higher alcohol, which were the same as those used in Example 1.

The solution thus prepared was added with 100 parts by mass of Neocoal SW-C (manufactured by Dai-ichi Kogyo Seiyaku Co., Ltd.) as a surfactant, and then added with 225 parts by mass of water, thereby forming emulsion.

The resultant emulsion solution was heated to 80° C. and then the monomers were polymerized, thereby obtaining resin composite particles.

The particle sizes of the resin composite particles prepared in Examples 1 to 3 and Comparison 1 were measured using an electrophoretic light scattering photometer ELS-800 (manufactured by Otsuka Electronics, Co., Ltd.). The results are listed in Table 1.

TABLE 1

| | Average particle size (nm) |
|---|---|
| Example 1 | 300 |
| Example 2 | 300 |
| Example 3 | 220 |
| Comparison 1 | 1100 |

As is evident from Table 1, minute resin composite particles with an average particle size of 300 nm were obtained in Example 1 and Example 2, respectively. In Example 3, resin composite particles with an average particle size of 220 nm were obtained. In contrast, Comparison 1, in which the concentrations of active components in emulsion were increased, the resultant average particle size thereof was as high as 1100 nm, and minute resin composite particles could not be obtained.

Next, a fiber treating agent was prepared by mixing the resin composite particles with an adhesive resin and textile was then treated with the fiber treating agent, on which evaluation on the functional component after washing was conducted.

### Example 4

A fiber treating agent was obtained by adding 80 parts by mass of “LightEpoch S86” (solid: 25% by mass) (manufactured by Kyoeisha Chemical, Co., Ltd.) as acryl-silicon adhesive resin emulsion to 100 parts by mass of water emulsion of the resin composite particles prepared in Example 1 (resin composite particles: 32.5% by mass), and then mixing, stirring, and dispersing the respective components using a homomixer. The solid weight ratio of the respective components is 32.5:20 (resin composite particles adhesive resin). Further, the fiber treating agent thus prepared was diluted with water and then used for textile processing.

The weight ratios of the respective components were as listed below.

| | Liquid % by mass | Solid % by mass |
|---|---|---|
| Resin composite particle emulsion | 15.4% | 5.0% |
| Light Epoch S86 | 12.3% | 3.1% |
| Water | 72.3% | |

### Example 5

A fiber treating agent was prepared in a similar manner as that of Example 4 except that the parts of Light Ephoch S86 was changed to 26 parts by mass, and then diluted with water and used for textile processing.

The weight ratios of the respective components were as listed below.

| | Liquid % by mass | Solid % by mass |
|---|---|---|
| Resin composite particle emulsion | 15.4% | 5.0% |
| Light Epoch S86 | 4.0% | 1.0% |
| Water | 80.6% | |

### Example 6

A fiber treating agent was prepared in a similar manner as that of Example 4 except that the parts of Light Ephoch S86 was changed to 520 parts by mass, and then diluted with water and used for textile processing.

The weight ratios of the respective components were as listed below.

| | Liquid % by mass | Solid % by mass |
|---|---|---|
| Resin composite particle emulsion | 15.4% | 5.0% |
| Light Epoch S86 | 80.0% | 20.0% |
| Water | 4.6% | |

### Example 7

A fiber treating agent was prepared in a similar manner as that of Example 4 except that 100 parts by weight of the water emulsion of resin composite particles prepared in Example 2 (resin composite particles: 32.5% by mass) was u [symbol] sed instead of 100 parts by mass of the water emulsion of resin composite particles prepared in Example 1 (resin composite particles: 32.5% by mass), and then diluted with water and used for textile processing.

The weight ratios of the respective components were as listed below.

| | Liquid % by mass | Solid % by mass |
|---|---|---|
| Resin composite particle emulsion | 15.4% | 5.0% |
| Light Epoch S86 | 80.0% | 3.1% |
| Water | 72.3% | |

### Example 8

A fiber treating agent was obtained by adding 80 parts by mass of “LightEpoch S86” (solid: 25% by mass) (manufactured by Kyoeisha Chemical, Co., Ltd.) as acryl-silicon adhesive resin emulsion and 160 parts by mass of desalted water to 100 parts by mass of water emulsion of the resin composite particles prepared in Example 3 (resin composite particles: 34.0% by mass), and then mixing, stirring, and dispersing the mixture using a homomixer. The solid weight ratio of the respective components is 34:20 (resin composite particles:adhesive resin). Further, the fiber treating agent thus prepared was diluted with water and then used for textile processing. The weight ratios of the respective components were as listed below.

| | Liquid % by mass | Solid % by mass |
|---|---|---|
| Resin composite particle emulsion | 29.4% | 10.0% |
| Light Epoch S86 | 23.5% | 5.9% |
| Water | 47.1% | |

[Comparison 2]

A fiber treating agent was prepared in a similar manner as that of Example 4 except that 50 parts by weight of the water emulsion of resin composite particles prepared in Comparison 1 (resin composite particles: 65.0% by mass) was used instead of 100 parts by mass of the water emulsion of resin composite particles prepared in Example 1 (resin composite particles: 32.5% by mass), and then diluted with water and used for textile processing.

The weight ratios of the respective components were as listed below.

| | Liquid % by mass | Solid % by mass |
|---|---|---|
| Resin composite particle emulsion | 7.7% | 5.0% |
| Light Epoch S86 | 12.3% | 3.1% |
| Water | 80.0% | |

A cotton fabric (standard adjacent fabric, canequim 3, cut into 20 cm square) was immersed for 1 minute at an ambient temperature in each of the fiber treating agents prepared in Examples 4 to 7 and Comparison 2, and then drawn (pick up rate: 96%) with a mangle where the pressure between rollers was set to 0.4 M Pa, followed by drying for 10 minutes at 110° C. with a hot-air drier. The textile was washed one time in compliance with JIS L0217 103 method, and then dried for 20 minutes at 80° C.

The textiles thus treated with the fiber treating agents were washed 10 times and washed 30 times.

One cycle of the washing of the textile was carried out such that a commercially-available automatic washing machine for home use was filled with water up to a standard water volume, added with a commercially-available washing detergent at a rate of standard usage, and washing for 5 minutes, rinsing of one time (for two minutes) and centrifugal dehydration of the textile were performed. After washing required number of times, the textile was dried for 20 minutes at 60° C. with a hot-air drier and then finished with a dry iron at an appropriate temperature of the fiber material.

The fiber treating agent prepared in Example 8 was placed in a polyethylene spray container for home use and then uniformly sprayed on an acrylic knitting (weight: 120 g), which was cut into 20 cm square, with a liquid weight of 5 g in total. The wet texture was dried for 1 hour with a hot-air drier set at 70° C., thereby obtaining processed knitting.

[Contents of Evaluation]

After washing the textile, the functional properties of the aromatic components were evaluated as follows:

“A”: with aromatic odor

“B”: with slight aromatic odor

“C”: with no aromatic odor at all

TABLE 2

| | Washing 1 time | Washing 10 times | Washing 30 times |
|---|---|---|---|
| Example 4 | A | A | A |
| Example 5 | A | A | A |
| Example 6 | B | B | B |
| Example 7 | A | B | B |
| Comparison 2 | A | C | C |

As is evident from Table 2, in Example 4 and Example 5, the functional properties of the aromatic components were sufficiently exerted even after washing 30 times.

In contrast, in Example 6, a decrease in an aromatic property was observed from an early stage because of an excess amount of the adhesive. However, even after washing 30 times, a further decrease was not observed.

In Example 7, regarding the release of the aromatic component from the resin composite particles, it was verified that the aromatic property was retained even though the performance thereof was inferior to that of Example 4.

In Comparison 2, it was verified that the resin composite particles were so large that the particles tended to be dropped off by washing even though the initial aromatic property thereof was observed.

As described above, the fiber treating agent of the present invention can retain good effects by controlling the particle size of the resin composite particles and controlling the ratio thereof to the adhesive component.

### INDUSTRIAL APPLICABILITY

The present invention can be applied to synthetic fiber such as polyester and semisynthetic fiber such as acetate and also applied to regenerated fiber, natural protein fiber, natural cellulose fiber, and the like.

1. A method of manufacturing a resin composite particle contained in a fiber treating agent to be used in treatment of a surface of fiber, comprising:
adding a surfactant and water to a solution containing at least a functional component and a monomer to make an emulsion;
adjusting a total concentration of the functional component and the monomer in the emulsion containing the functional component, the monomer, the surfactant, and the water to 10 to 50%; and
polymerizing a mixture of the solution, the surfactant, and the water by application of heat or ultraviolet radiation to obtain a resin composite particle.

2. The method of manufacturing a resin composite particle according to claim 1, wherein the application of heat is carried out at a temperature of 50 to 120° C.

3. The method of manufacturing a resin composite particle according to claim 1, wherein one of a higher alcohol having 6 or more carbon atoms, a mineral oil, and a vegetable oil is added to the solution containing the functional component and the monomer.

4. The method of manufacturing a resin composite particle according to claim 1, wherein the functional component has a LogPow value (n-octanol/water partition coefficient) of zero (0) or more.

5. The method of manufacturing a resin composite particle according to claim 1, wherein the functional component is a composite containing an oligopeptide in which N-terminal is bounded by aliphatic fatty acid to form an amide bond.

6. The method of manufacturing a resin composite particle according to claim 1, wherein the functional component is a plant-origin aromatic component.

7. The method of manufacturing a resin composite particle according to claim 1, wherein the functional component is a hydrophobized degenerated substance of a polyphenol.

8. The method of manufacturing a resin composite particle according to claim 1, wherein the monomer is comprised of at least one of acrylic-based, methacrylic acid-based, maleic acid-based, vinyl ester-based, vinyl ether-based, and styrene-based monomers.

9. The method of manufacturing a resin composite particle according to claim 1, wherein the resin composite particle is manufactured with a weight ratio of the functional component to the monomer being in the range from 1:3 to 1:10 (the functional component: the monomer).

10. The method of manufacturing a resin composite particle according to claim 1, wherein the resin composite particle has an average particle size of 500 nm or less.

11. A method of manufacturing a fiber treating agent, comprising: mixing the resin composite particle manufactured by the method of manufacturing a resin composite particle according to claim 1 with an adhesive resin.

12. The method of manufacturing a fiber treating agent according to claim 11, wherein the adhesive resin is comprised of at least one of acrylic-based, silicon-based, and polyurethane-based resins.

13. The method of manufacturing a fiber treating agent according to claim 11, wherein the fiber treating agent is manufactured such that a solid weight ratio of the resin composite particle to the adhesive resin is in the range from 2:3 to 10:1 (the resin composite particle:the adhesive resin).

14. A resin composite particle which is manufactured by the method of manufacturing a resin composite particle according to claim 1.

15. A fiber treating agent which is manufactured by the method of manufacturing a fiber treating agent according to claim 11.
